(19) United States
(12) Patent Application Publication
(10) Pub. No.: US 2020/0250577 A1
(43) Pub. Date: Aug. 6, 2020

(54) RISK EVALUATING METHOD BASED ON DEEP LEARNING, SERVER, AND COMPUTER-READABLE STORAGE MEDIUM

(71) Applicant: Shenzhen Fugui Precision Ind. Co., Ltd., Shenzhen (CN)

(72) Inventor: SHIH-CHENG WANG, New Taipei (TW)

(21) Appl. No.: 16/412,840

(22) Filed: May 15, 2019

(30) Foreign Application Priority Data
Jan. 31, 2019 (CN) 201910099943.7

(51) Int. Cl. G06N 20/00; G06Q 10/06

(52) U.S. Cl. CPC G06N 20/00; G06Q 10/0635

(57) ABSTRACT

A risk evaluating method based on deep learning includes establishing an evaluation model of factor weights and an evaluation model of factor scores by training weight data and score data of multiple factors; acquiring factor information in a current environment; inputting the factor information into the evaluation models of the factor weights and the factor scores; calculating dynamic weight data and score data of multiple factors; determining whether the current environment satisfies a predefined first environmental important characteristic condition; sampling the weight data and the score data of the multiple factors, when the current environment satisfies the predefined first environmental important characteristic condition; and adjusting the evaluation models of the factor weights and the factor scores respectively by training the sampled weight data and the sampled score data of the multiple factors.

### CROSS-REFERENCE TO RELATED APPLICATIONS

This application claims priority to Chinese Patent Application No. 201910099943.7 filed on Jan. 31, 2019, the contents of which are incorporated by reference herein.

### FIELD

The subject matter herein generally relates to risk evaluation technology, and particularly to a risk evaluating method based on deep learning, a server, and a computer-readable storage medium.

### BACKGROUND

AI (Artificial intelligence) technology is commonplace, and machine learning is commonly used in AI technology. Big data is collected including a large amount of industry knowledge in a given field, and certain laws can be inferred from such data by simulating human brain learning (such as deep learning). A decision-making recommendation can also be achieved. However, an evaluation model (such as risk evaluation) based on deep learning still requires quantitative evaluations by experts, and cannot be automatically adjusted in conjunction with environmental changes, which leads to a reduction in accuracy of evaluation results.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an embodiment of an application environment of a server.

FIG. 2 is a block diagram of an embodiment of a server.

FIG. 3 is a block diagram of an embodiment of a risk evaluating system.

FIG. 4 is a schematic diagram of an embodiment of a neural network in the system of FIG. 3.

FIG. 5 illustrates a flowchart of an embodiment of a risk evaluating method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series, and the like.

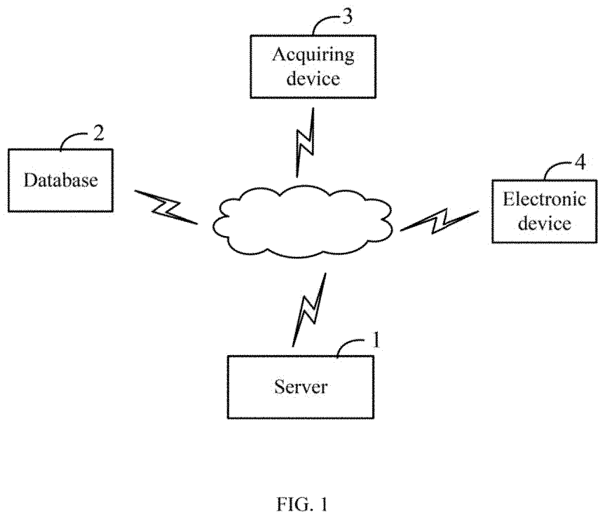

FIG. 1 illustrates an embodiment of an application environment of a server 1. The server 1 can communicate with at least one database 2, an acquiring device 3, and an electronic device 4, through a network. In at least one embodiment, the network can be a wired network or a wireless network, such as radio, WI-FI, cellular network etc.

In at least one embodiment, the server 1 can be a single server, a cloud server, or cluster of servers. The database 2 provides data access for the server 1. The acquiring device 3 can be an electronic device having at least one sensing device, and is used for collecting environmental information based on a deep learning project. The electronic device 4 can be a smart terminal device, such as a smart phone, a tablet, a laptop computer, or a desktop computer etc.

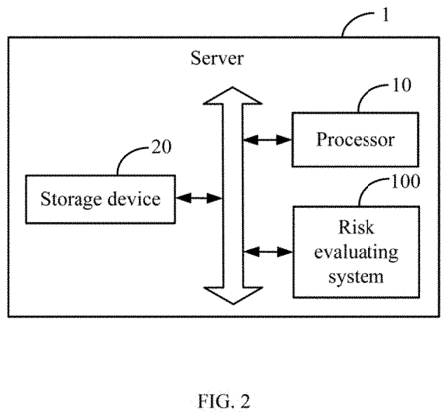

Referring to FIG. 2, the server 1 includes, but is not limited to, a processor 10 and a storage device 20. The server 1 further runs a risk evaluating system 100. FIG. 2 illustrates only one example of the server 1, other examples can include more or fewer components than illustrated, or can have a different configuration of the various components in other embodiments.

The at least one processor 10 can be a central processing unit (CPU), a microprocessor, or other data processor chip that performs functions of the electronic device 1.

In at least one embodiment, the storage device 20 can include various types of non-transitory computer-readable storage mediums. For example, the storage device 20 can be an internal storage system, such as a flash memory, a random access memory (RAM) for temporary storage of information, and/or a read-only memory (ROM) for permanent storage of information. The storage device 20 can also be an external storage system, such as a hard disk, a storage card, or a data storage medium. In at least one embodiment, the storage device 20 stores a number of applications of the server 1.

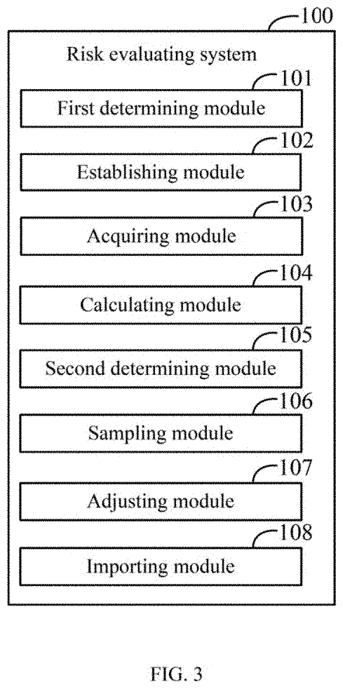

Referring to FIG. 3, the risk evaluating system 100 at least includes a first determining module 101, an establishing module 102, an acquiring module 103, a calculating module 104, a second determining module 105, a sampling module 106, an adjusting module 107, and an importing module 108. The modules 101-108 can be collections of software instructions stored in the storage device 20 of the server 1 and executed by the processor 10. The modules 101-108 also can include functionality represented as hardware or integrated circuits, or as software and hardware combinations, such as a special-purpose processor or a general-purpose processor with special-purpose firmware.

The first determining module 101 is used to determine multiple factors, weight data of each factor, and score data of each factor through Analytic Hierarchy Process (AHP).

A certain area of fire risk in a certain facility is put forward as an example in a risk-evaluating project.

For example, according to the AHP, the factors that affect the risk of fire in the facility in the area can be divided into condition of fire-detecting equipment in a fire protection system, condition of fire-fighting and rescue equipment, and condition of fire-escape equipment and arrangements. Furthermore, the factors that affect the condition of fire-detecting equipment in the fire protection system includes proper rate of packet smoke detectors, proper rate of manual alarm buttons, proper rate of spray signal valves, and proper rate of spray pressure switches etc.

Furthermore, the first determining module 101 generates a comparative matrix, by pairwise comparisons between the factors that affect the condition of fire-detecting equipment, according to expert experience. Relative importance between the factors is determined, and weight data of each factor are determined by an attribution method. In at least one embodiment, the first determining module 101 allocates a score for each factor according to multi-level fuzzy comprehensive evaluation and expert experience.

The establishing module 102 is used to establish an evaluation model of factor weight and an evaluation model of factor score by training the weight data and the score data of multiple factors.

In at least one embodiment, the establishing module 102 determines current information relating to each factor (factor information), converts the factor information, the weight data, and the score data to components between 0 and 1, and inputs the converted factor information, the converted weight data of each factor, and the converted score data of each factor into a neural network for training.

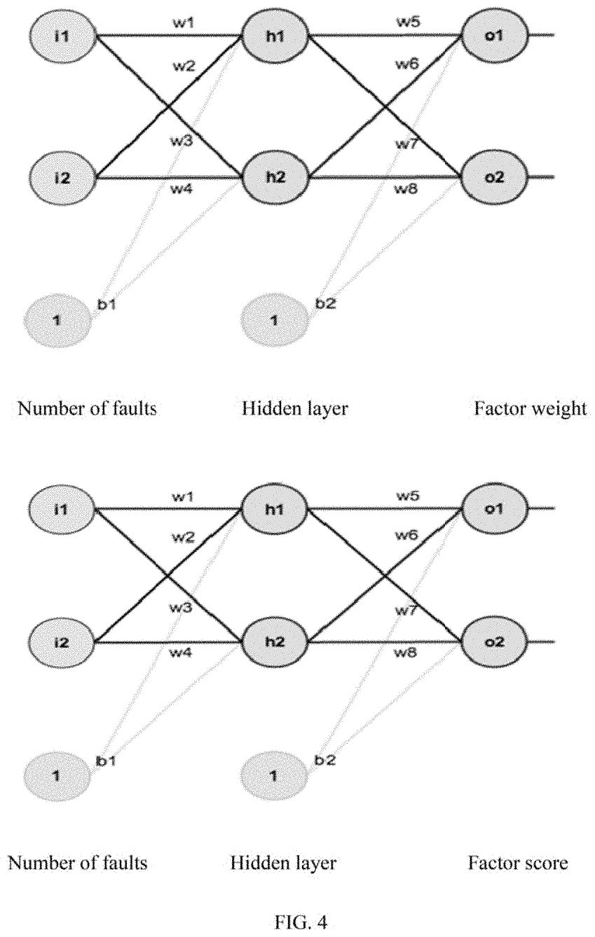

Referring to FIG. 4, in at least one embodiment, the factor information can be a number of faults of each factor. The factor information is taken as an input layer of the neural network, the weight data and the score data are respectively taken as a target output layers of the neural network.

The establishing module 102 respectively trains the weight data and the score data of the factor in the neural network, until actual output values and target output values are within an allowable error range. An initial evaluation model of the factor weight and an initial evaluation model of the factor score are thus established.

In detail, the establishing module 102 makes forward transfer calculation based on the neural network, and calculates an actual output value of each nerve cell of the neural network according to the input factor information using following (equation 1):

$${O}_{j} = f ( {x}_{j} ) = \frac{1}{1 + exp ( - {x}_{j} )} . \qquad ( 1 )$$

In the equation 1, Oⱼ is an output item, xᵢ is a weighted cumulative number. xᵢ is calculated using following (equation 2):

$${x}_{j} = {\sum }_{i} {w}_{j i} {i}_{i} + {b}_{i} . \qquad ( 2 )$$

In the equation 2, bᵢ is a partial weight value, wⱼᵢ is a weight value, and iᵢ is the input number of faults.

The establishing module 102 further makes backward transfer calculation base on the neural network, to calculate a difference value between the target output value and the actual output value using following (equation 3):

δᵢ=Oⱼ(1−Oⱼ)(Tᵢ−Oⱼ) (3).

In the equation 3, δᵢ is the difference value, and T₁ is an target output quantity.

The establishing module 102 further calculates a partial weight value using following (equation 4):

Δbᵢ=ηδᵢ (4).

In the equation 4, Δbᵢ is the partial weight value, and η is a learning rate of a machine which is used for control a weight correction amplitude.

The establishing module 102 further calculates a weight variable using following (equation 5):

Δwⱼᵢ=xⱼηδᵢ (5).

The establishing module 102 further corrects a next partial weight value using following (equation 6):

bᵢ₊₁=bᵢ+Δbᵢ (6).

The establishing module 102 further corrects a next weight value using following (equation 7):

wⱼᵢ₊₁=wⱼᵢ+Δwⱼᵢ (7).

In at least one embodiment, the establishing module 102 further stores the established evaluation model of factor weight and the established evaluation model of factor score into the database 2.

The acquiring module 103 is used to control the acquiring device 3 to acquire the factor information in a current environment.

In at least one embodiment, the acquiring module 103 transmits an instruction to the acquiring device 3, the acquiring device 3 detects and acquires information relating to each factor in the current environment. In at least one embodiment, the information can be the number of faults of each item of fire-fighting equipment. The acquiring device 3 further returns the acquired factor information in the current environment to the server 1.

The calculating module 104 is used to input the factor information in the current environment into the evaluation models of the factor weight and factor score, and calculate dynamic weight data and score data of multiple factors in the current environment.

In at least one embodiment, the calculating module 104 converts the factor information, that is, the number of faults of each piece of fire-fighting equipment, to components between 0 and 1, inputs the number of faults into the evaluation models of the factor weight and factor score respectively, calculates a corresponding weight data according to the equation 1, and calculates a corresponding score data according to the equation 2.

The first determining module 101 is further used to determine a current risk evaluation result by inputting the dynamic weight data and score data of multiple factors in the current environment into a risk evaluation model.

In at least one embodiment, the first determining module 101 calculates a fire-risk value according to the input dynamic weight data and score data of multiple factors and the risk evaluation model, the fire-risk value will be the final result of the current risk evaluation.

In detail, the first determining module 101 calculates the fire-risk value using following (equation 8):

$$D = 10 - {H}_{k} = 10 - \frac{1}{2} [ {\sum }_{i = 1}^{k} {b}_{i} ( {D}_{i ( max )} - {b}_{i} ) + {\sum }_{i = 1}^{k} {b}_{i} ( {{D}_{i}}_{( min )} + {b}_{i} ) ] . \qquad ( 8 )$$

In the equation 8, D is the fire-risk value, Hₖ is a value of safety level, Dᵢ₍ₘₐₓ₎ is a maximum value of the safety level, and Dᵢ₍ₘᵢₙ₎ is a minimum value of the safety level.

The second determining module 105 is used to determine whether the current environment satisfies a predefined first condition in respect of environmental important characteristic (first condition).

In at least one embodiment, the first condition can be a lower threshold value of a predefined range of total score value of multiple factors.

The second determining module 105 determines whether the total score of multiple factors in the current environment is less than the lower threshold value of the predefined range of total score value of multiple factors. When the total score of multiple factors in the current environment is less than the lower threshold value, the current environment is deemed to satisfy the first condition.

When the total score of multiple factors in the current environment is greater than or equal to the lower threshold value of the predefined range of total score value of multiple factors, the current environment is deemed to not satisfy the first condition.

When the current environment satisfies the first condition, the sampling module 106 is used to sample the weight data and score data of the multiple factors.

The adjusting module 107 is used to respectively adjust the evaluation models of factor weight and factor score, by training the sampled weight data and score data of the multiple factors.

The second determining module 105 is further used to determine whether the current environment satisfies a predefined second condition in respect of environmental important characteristic (second condition).

In at least one embodiment, the second condition can be an upper threshold value of the predefined range of total score value of multiple factors. When the evaluation models of factor weight and factor score are adjusted, the second determining module 105 determines whether the total score of multiple factors in the current environment is greater than or equal to the upper threshold value of the predefined range of total score value of multiple factors

When the second determining module 105 determines that the total score of multiple factors in the current environment is greater than or equal to the upper threshold value, the current environment is deemed to satisfy the second condition.

When the second determining module 105 determines that the total score of multiple factors in the current environment is not greater than or equal to the upper threshold value, the current environment is deemed to not satisfy the second condition. Thereupon, the calculating module 104 respectively inputs the factor information in the current environment into the evaluation models of the factor weight and factor score, and calculates the dynamic factor weight data and factor score data in the current environment.

When the current environment does satisfy the second condition, the importing module 108 is used to import the adjusted evaluation models of factor weight and factor score into the risk evaluation model.

When the importing module 108 imports the adjusted evaluation models of factor weight and factor score into the risk evaluation model, the calculating module 104 inputs the factor information in the current environment into the adjusted evaluation models of the factor weight and factor score, and calculates the dynamic factor weight data and factor score data in the current environment.

The processor 10 can transmit a risk evaluation result calculated by the adjusted evaluation model to the electronic device 4 of the user, the electronic device 4 can transmit feedback from the user to the server 1, the server 1 can keep or correct the evaluation model according to the feedback.

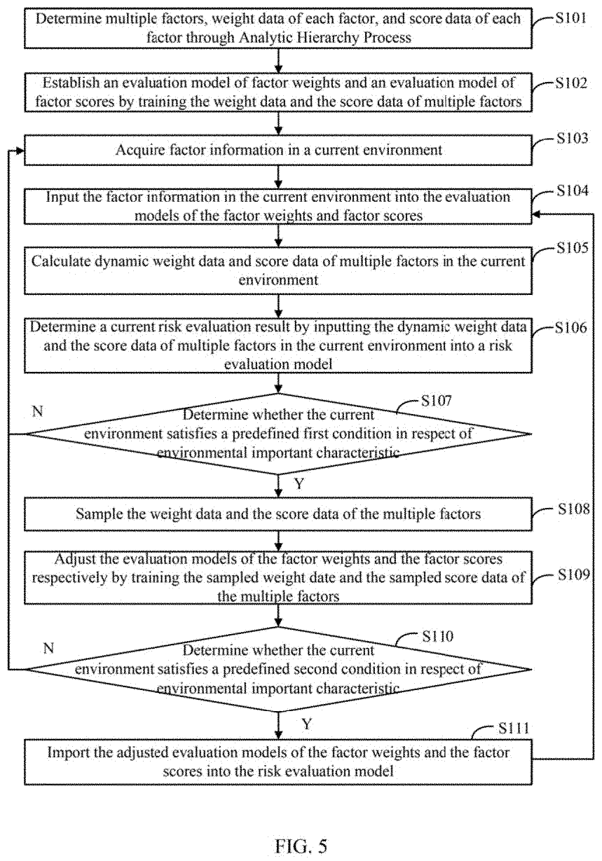

FIG. 5 illustrates a flowchart of an embodiment of a risk evaluating method. The method is provided by way of example, as there are a variety of ways to carry out the method. The method described below can be carried out using the configurations illustrated in FIG. 1-3, for example, and various elements of these figures are referenced in explaining the example method. Each block shown in FIG. 5 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 101.

At block 101, a first determining module determines multiple factors, weight data of each factor, and score data of each factor through Analytic Hierarchy Process (AHP).

At block 102, an establishing module establishes an evaluation model of factor weight and an evaluation model of factor score by training the weight data and score data of multiple factors.

At block 103, an acquiring module controls the acquiring device 3 to acquire the factor information in the current environment.

At block 104, a calculating module inputs the factor information in the current environment into the evaluation models of the factor weight and factor score.

At block 105, the calculating module further calculates dynamic weight data and score data of multiple factors in the current environment.

At block 106, the first determining module further determines a current risk evaluation result by inputting the dynamic weight data and score data of multiple factors in the current environment into a risk evaluation model.

At block 107, a second determining module determines whether the current environment satisfies a predefined first condition in respect of environmental important characteristic (first condition). When the second determining module determines that the current environment does satisfy the first condition, the process jumps to block 108. When the second determining module determines that the current environment does not satisfy the first condition, the process goes back to block 103.

At block 108, a sampling module 106 samples the weight data and score data of the multiple factors.

At block 109, an adjusting module 107 respectively adjusts the evaluation models of factor weight and factor score by training the sampled weight data and score data of the multiple factors.

At block 110, the second determining module 105 further determines whether the current environment satisfies a predefined second condition in respect of environmental important characteristic (second condition). When the second determining module 105 determines that the current environment does satisfy the second condition, the process jumps to block 111. When the second determining module 105 determines that the current environment does not satisfy the predefined second environmental important characteristic condition, the process goes back to block 103.

At block 111, an importing module 108 imports the adjusted evaluation models of factor weight and factor into the risk evaluation model, and then the process goes back to block 104.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A risk evaluating method based on deep learning applied in a server comprising:
establishing an evaluation model of factor weights and an evaluation model of factor scores by training weight data and score data of multiple factors;
acquiring factor information in a current environment;
inputting the factor information in the current environment into the evaluation models of the factor weights and the factor scores;
calculating dynamic weight data and score data of multiple factors in the current environment;
determining a current risk evaluation result by inputting the dynamic weight data and the score data of multiple factors in the current environment into a risk evaluation model;
determining whether the current environment satisfies a predefined first condition in respect of environmental important characteristic;
sampling the weight data and the score data of the multiple factors, when the current environment satisfies the predefined first condition in respect of environmental important characteristic; and
adjusting the evaluation models of the factor weights and the factor scores respectively by training the sampled weight data and the sampled score data of the multiple factors.

2. The method according to claim 1, further comprising:
acquiring the factor information in the current environment, when the current environment does not satisfy the predefined first condition in respect of environmental important characteristic;
inputting the factor information in the current environment into the evaluation models of the factor weights and factor scores; and
calculating dynamic weight data and score data of multiple factors in the current environment.

3. The method according to claim 1, further comprising:
determining whether the current environment satisfies a predefined second condition in respect of environmental important characteristic;
inputting the factor information in the current environment into the evaluation models of the factor weights and the factor scores, when the current environment satisfies the predefined second condition in respect of environmental important characteristic; and
calculating dynamic weight data and score data of multiple factors in the current environment.

4. The method according to claim 1, further comprising:
determining the multiple factors, the weight data of each factor, and the score data of each factor through Analytic Hierarchy Process.

5. The method according to claim 1, the method of establishing an evaluation model of factor weight and factor score by training the weight data and score data of multiple factors comprises:
training the weight data and the score data of the factor in a neural network respectively, until actual output values and target output values are within an allowable error range; and
establishing the evaluation model of the factor weights and the evaluation model of the factor scores.

6. The method according to claim 1, the method of determining a risk evaluation result comprises:
calculating a risk value according to the input dynamic weight data and the score data of multiple factors and the risk evaluation model.

7. The method according to claim 1, wherein the first condition in respect of environmental important characteristic is a lower threshold value of a predefined range of total score value of multiple factors, the method of determining whether the current environment satisfies the predefined first condition in respect of environmental important characteristic comprises:
determining whether the total score of multiple factors in the current environment is less than the lower threshold value of the predefined range of total score value of multiple factors.

8. A server comprising:
at least one processor; and
a storage device coupled to the at least one processor and storing instructions for execution by the at least one processor to cause the at least one processor to:
establish an evaluation model of factor weights and an evaluation model of factor scores by training weight data and score data of multiple factors;
acquire factor information in a current environment;
input the factor information in the current environment into the evaluation models of the factor weights and the factor scores;
calculate dynamic weight data and score data of multiple factors in the current environment;
determine a current risk evaluation result by inputting the dynamic weight data and the score data of multiple factors in the current environment into a risk evaluation model;
determine whether the current environment satisfies a predefined first environmental important characteristic condition;
sample, when the current environment satisfies the predefined first condition in respect of environmental important characteristic, the weight data and the score data of the multiple factors; and
adjust the evaluation models of the factor weights and the factor scores respectively by training the sampled weight data and the sampled score data of the multiple factors.

9. The server according to claim 8, wherein the at least one processor is further caused to:
acquire, when the current environment does not satisfy the predefined first condition in respect of environmental important characteristic, the factor information in the current environment;
input the factor information in the current environment into the evaluation models of the factor weights and the factor scores; and
calculate dynamic weight data and score data of multiple factors in the current environment.

10. The server according to claim 8, wherein at least one processor is further caused to:
determine whether the current environment satisfies a predefined second condition in respect of environmental important characteristic;
input, when the current environment satisfies the predefined second condition in respect of environmental important characteristic, the factor information in the current environment into the evaluation models of the factor weights and factor scores; and
calculate dynamic weight data and score data of multiple factors in the current environment.

11. The server according to claim 8, wherein the at least one processor is further caused to:
determine the multiple factors, the weight data of each factor, and the score data of each factor through Analytic Hierarchy Process.

12. The server according to claim 8, wherein the at least one processor is further caused to:
train the weight data and the score data of the factor in a neural network respectively, until actual output values and target output values are within an allowable error range; and
establish the evaluation model of the factor weights and the model of the factor scores.

13. The server according to claim 8, wherein the at least one processor is further caused to:
calculate a risk value according to the input dynamic weight data and the score data of multiple factors and the risk evaluation model.

14. The server according to claim 8, wherein the first condition in respect of environmental important characteristic is a lower threshold value of a predefined range of total score value of multiple factors, the at least one processor is further caused to:
determine whether the total score of multiple factors in the current environment is less than the lower threshold value of the predefined range of total score value of multiple factors.

15. A computer-readable storage medium having instructions stored thereon, when the instructions are executed by a processor of a server, the processor is configured to perform a risk evaluating method based on deep learning, wherein the method comprises:
establishing an evaluation model of factor weights and an evaluation model of factor scores by training weight data and score data of multiple factors;
acquiring factor information in a current environment;
inputting the factor information in the current environment into the evaluation models of the factor weights and the factor scores;
calculating dynamic weight data and score data of multiple factors in the current environment;
determining a current risk evaluation result by inputting the dynamic weight data and the score data of multiple factors in the current environment into a risk evaluation model;
determining whether the current environment satisfies a predefined first environmental important characteristic condition;
sampling the weight data and the score data of the multiple factors, when the current environment satisfies the predefined first condition in respect of environmental important characteristic; and
adjusting the evaluation models of the factor weights and the factor scores respectively by training the sampled weight data and the sampled score data of the multiple factors.

16. The computer-readable storage medium according to claim 15, further comprising:
acquiring the factor information in the current environment, when the current environment does not satisfy the predefined first condition in respect of environmental important characteristic;
inputting the factor information in the current environment into the evaluation models of the factor weights and factor scores; and
calculating dynamic weight data and score data of multiple factors in the current environment.

17. The computer-readable storage medium according to claim 15, further comprising:
determining whether the current environment satisfies a predefined second condition in respect of environmental important characteristic;
inputting the factor information in the current environment into the evaluation models of the factor weights and the factor scores, when the current environment satisfies the predefined second condition in respect of environmental important characteristic; and
calculating dynamic weight data and score data of multiple factors in the current environment.

18. The computer-readable storage medium according to claim 15, further comprising:
determining the multiple factors, the weight data of each factor, and the score data of each factor through Analytic Hierarchy Process.

19. The computer-readable storage medium according to claim 15, the method of establishing an evaluation model of factor weight and factor score by training the weight data and score data of multiple factors comprises:
training the weight data and the score data of the factor in a neural network respectively, until actual output values and target output values are within an allowable error range; and
establishing the evaluation model of the factor weights and the evaluation model of the factor scores.

20. The computer-readable storage medium according to claim 15, wherein the first condition in respect of environmental important characteristic is a lower threshold value of a predefined range of total score value of multiple factors, the method of determining whether the current environment satisfies the predefined first environmental important characteristic condition comprises:
determining whether the total score of multiple factors in the current environment is less than the lower threshold value of the predefined range of total score value of multiple factors.
